(19) United States
(12) Patent Application Publication
(10) Pub. No.: US 2008/0201294 A1
(43) Pub. Date: Aug. 21, 2008

(54) Community-Based Strategies for Generating Reports

(75) Inventor: Ross A. Norrie, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/675,463

(22) Filed: Feb. 15, 2007

(51) Int. Cl. G06F 17/30

(52) U.S. Cl. 707/2

(57) ABSTRACT

A strategy is described for maintaining a plurality report logic units in a network-accessible community report system. An agnostic reporting module in a local environment can peruse the reports offered by the community report system and download a report logic unit corresponding to a selected report. The reporting module generates the report using a mapping module. The mapping module maps data fields identified in the downloaded report logic unit to one or more data sources. The mapping module uses a data connector to establish a link between the data fields and data sources. This strategy provides a mechanism by which an entity can be conveniently informed of relevant issues that may affect it.

### BACKGROUND

An administrator of an organization may generate reports to address various issues that concern the organization. For example, an administrator in charge of the data processing infrastructure of an organization may generate reports to identify various actions that need to be performed on the computers used within the organization. The reports can address upgrade-related issues, licensing-related issues, recall-related issues, compatibility-related issues, and so on.

The administrator can generate these reports in an ad hoc manner based on his or her knowledge of the prevailing needs within the organization. In one illustrative scenario, a manufacturer may notify an administrator that a hardware unit used by the organization's computers is defective and needs to be replaced. Based on this knowledge, the administrator can manually create a custom report to identify the computers that are affected by this recall.

As appreciated by the present inventor, the above-described approach to generating reports has shortcomings. Most notably, there is a vast amount of information that may have a bearing on a particular organization. An administrator cannot be expected to keep abreast of all pertinent events that may affect an organization. Consequently, the administrator may fail to take appropriate action in a timely fashion, which, in turn, may negatively affect the organization.

Further, even when an administrator is expressly notified of actionable events, it may be a time-consuming and error-prone task to generate reports concerning the events. The administrator may rely on various “canned” reports, yet these reports may not adequately serve the administrator's needs in every case. An administrator may be forced to customize these generic reports, or, in the worst case, start from “scratch” in generating appropriate reports. The quality of these reports may ultimately depend on the expertise of the administrator; as the expertise of administrators can be expected to vary, so can the quality of their reports.

### SUMMARY

A strategy is described for enabling a local environment to generate reports using a community report system. The community report system maintains a plurality of report logic units (RLUs). Each RLU identifies at least one query that may be posed within the local environment regarding an issue of potential concern within the local environment. The community report system can organize the RLUs into a plurality of groups. The groups can have different characteristics. For example, some groups may be designated as private, other groups may be designated as public, and so forth.

A user can use an agnostic reporting module in a local environment to access the community report system. The reporting module and the community report system are coupled together via a network, such as the Internet. Upon access, the user can peruse the reports offered by the community report system and download a RLU corresponding to a desired report. The reporting module generates the desired report using a mapping module. The mapping module maps data fields identified in the RLU to one or more data sources. The mapping module can use a data connector (DC) to establish a link between the data fields and data sources.

A user in a local environment can also use an authoring module to create a new RLU (and/or associated DC). The user can post this new RLU (and/or associated DC) to the community report system. Other users can then rely on this new RLU (and/or associated DC) in generating reports in their own respective local environments. Since the community report system may include a great number of contributors, it may develop a particularly robust store of report topics that are pertinent to the needs of end users.

The strategy confers a number of benefits. According to one exemplary benefit, the strategy provides a mechanism by which an organization (or other entity) can be more reliably informed of relevant issues that may affect it. This reduces the organization's reliance on ad hoc personal knowledge of administrators in identifying relevant information. Once issues are identified, the strategy also provides a convenient mechanism that allows a user to generate reports. This reduces the time-consuming need to generate custom reports. The strategy also provides a vehicle whereby an organization can effectively rectify issues identified by generated reports.

The strategy also provides a mechanism by which an organization (or other entity) can conveniently share information regarding relevant issues with other organizations (or other entities). More specifically, by virtue of the RLUs, the issues can be framed as generic queries that are relevant to a plurality of organizations, regardless of the data storage frameworks employed by the organizations. By virtue of the DCs, individual organizations can map the generic queries to organization-specific data stores.

Additional exemplary implementations and attendant benefits are described in the following.

### BRIEF DESCRIPTION OF THE DRAWINGS

FIG. 1 shows an exemplary system that includes a community report system for maintaining a plurality of report logic units (RLUs) for access by agnostic reporting modules located in respective local environments.

FIG. 2 illustrates an exemplary operation of a mapping module employed by a reporting module.

FIG. 3 shows exemplary processing functionality that can be used to implement any aspect of the system of FIG. 1.

FIGS. 4-6 illustrate, from the perspective of a user, exemplary procedures which explain the manner of operation of the system of FIG. 1.

FIGS. 7-9 illustrate, from the perspective of the community report system, exemplary procedures which explain the manner of operation of the system of FIG. 1.

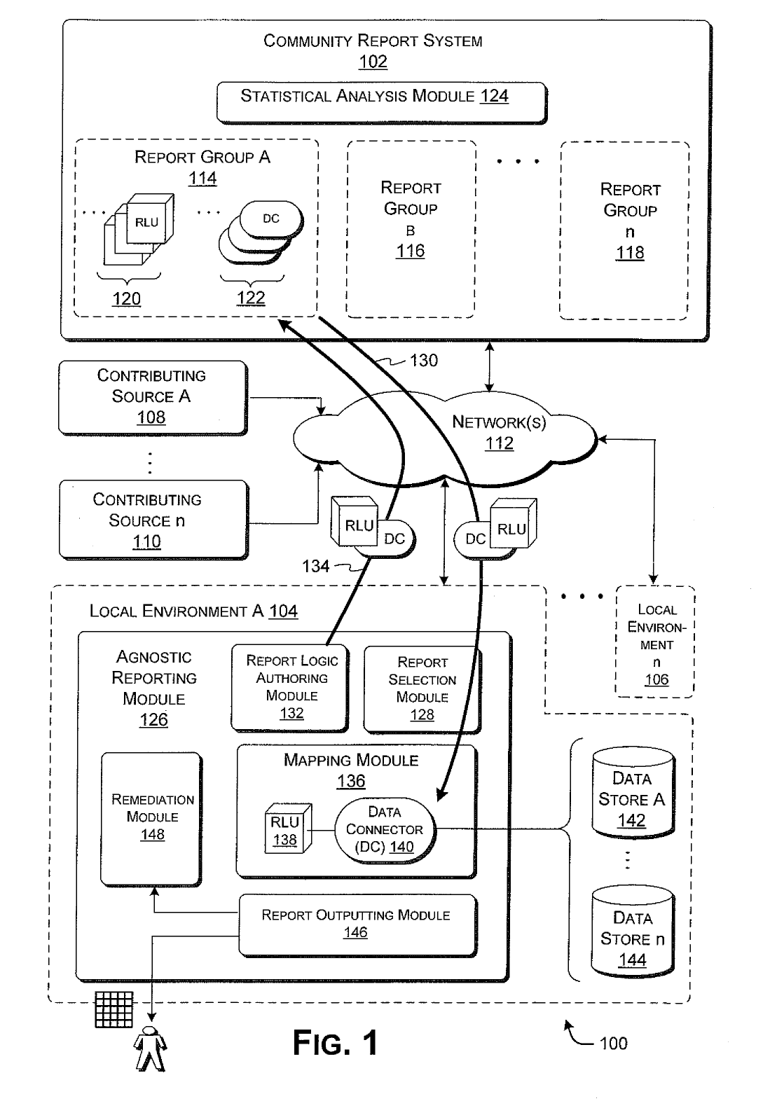

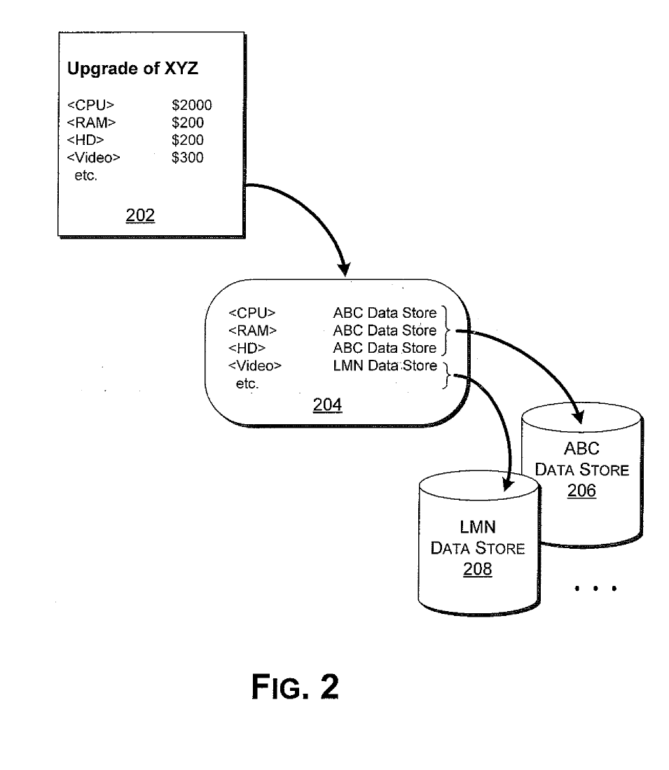

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

his disclosure sets forth a strategy for generating reports using a community report system. The strategy can be manifested in various systems, apparatuses, modules, procedures, storage mediums, data structures, and other forms.

This disclosure includes the following sections. Section A describes an exemplary system for generating reports. Section B describes exemplary procedures that explain the operation of the system of Section A.

A. Exemplary System

As a preliminary note, any of the functions described with reference to the figures can be implemented using software, firmware, hardware (e.g., fixed logic circuitry), manual processing, or a combination of these implementations. The term “logic, “module,” “component,” “system” or “functionality” as used herein generally represents software, firmware, hardware, or a combination of the elements. For instance, in the case of a software implementation, the term “logic,” “module,” “component,” “system,” or “functionality” represents program code that performs specified tasks when executed on a processing device or devices (e.g., CPU or CPUs). The program code can be stored in one or more computer readable memory devices.

More generally, the illustrated separation of logic, modules, components, systems, and functionality into distinct units may reflect an actual physical grouping and allocation of software, firmware, and/or hardware, or can correspond to a conceptual allocation of different tasks performed by a single software program, firmware program, and/or hardware unit. The illustrated logic, modules, components, systems, and functionality can be located at a single site (e.g., as implemented by a processing device), or can be distributed over plural locations.

The terms “machine-readable media” or the like refers to any kind of medium for retaining information in any form, including various kinds of storage devices (magnetic, optical, static, etc.). The term machine-readable media also encompasses transitory forms for representing information, including various hardwired and/or wireless links for transmitting the information from one point to another.

A.1. System Overview

FIG. 1 shows one exemplary community-based system 100 for generating reports. The system 100 includes a community report system 102. A plurality of local environments (104, . . . 106) can interact with the community report system 102. A plurality of contributing sources (108, . . . 110) can supply information to the community report system 102. One or more networks 112 communicatively couple all of the above-described components together. The following description explains each of these components of the system 100 in greater detail.

Starting with the community report system 102, this component corresponds to a network-accessible service for providing so-called report logic units (RLUs) to the local environments (104, . . . 106) for use in generating reports at the local environments (104, . . . 106). Each RLU identifies information that will be conveyed by a generated report. In other words, each RLU identifies one or more queries that will be answered by a report. No limitation is placed herein on the nature of the information that can be conveyed in the reports. No limitation is placed on the nature of the entities that can consume the reports in the local environments (104, . . . 106). For example, the reports can pertain to any topic of interest to private companies, charitable organizations, educational institutions, government entities, individuals (not acting on behalf of any type of organization), and so on.

Consider, for example, a representative scenario in which an organization employs a plurality of data processing devices (e.g., computers, storage devices, etc.). The community report system 102 can store a collection of RLUs that can be used within the organization to generate reports concerning this equipment. For example, the following list enumerates, without limitation, reports that can be generated based on associated RLUs:

A first illustrative report (and associated RLU) can identify equipment that needs to be replaced within the organization (e.g., in response to recall events).

A second illustrative report (and associated RLU) can identify software that needs to be added or modified within the organization in response to various events (e.g., in response to software upgrades, computer virus threats, etc.).

A third illustrative report (and associated RLU) can identify licensing issues within the organization. This type of report can convey information regarding existing licenses, expired licenses, licenses that need to be acquired, and so on.

A fourth illustrative report (and associated RLU) can identify the extent to which the equipment within the organization complies with certain standards or expectations.

A fifth illustrative report (and associated RLU) can identify computer-related compatibility issues within the organization.

To repeat, the community report system 102 can be used to generate many other types of reports for use in many other types of contexts. For instance, in an educational context, reports can be compiled to provide information regarding grade-related issues, affirmative action issues, attendance-related issues, and so on. In a government-related context, reports can be compiled to provide information regarding regional economic issues, demographic issues, and so on. In a context associated with a single individual or family, reports can be compiled to provide information regarding budget-related issues, healthcare-related issues, tax-related issues, and so on.

The exemplary structure of an RLU will be set forth in greater detail below in the context of the discussion of FIG. 2. By way of overview, a RLU can identify a plurality of data fields. The data fields may correspond to information to be collected for presentation in the report. Stated in another way, the RLU conveys to a question to be asked within a local environment that requires the collection of information associated with the data fields. Consider the illustrative example of a report that identifies computers within an organization that need new batteries (e.g., in response to a recall event). The RLU associated with this report can include a data field that identifies the devices that are affected by the recall. The RLU asks “What devices within this organization include batteries that need to be replaced?”

The RLU is expressed in a generic form that applies to many different local environments (104, . . . 106). Accordingly, the RLU itself does not identify the data sources within a local environment that can be mined to extract the data needed for the report. In fact, different local environments may store the information identified in an RLU in different types of data stores.

To enable a local environments (104, . . . 106) to utilize the generic RLUs, the community report system 102 also provides a plurality of data connectors (DCs). Each DC maps the data fields in an associated RLU into data sources used within a particular local environment. For example, assume that local environment X maintains information G in data store S, while local environment Y maintains the same information G in data store T. Next assume that both data environments wish to run a report associated with an RLU that relates to information G. A first DC₁ can be stored which maps information G to data store S (for use in local environment X), while a second DC₂ can be stored which maps information G to data store T (for use in local environment Y). Thus, for example, when a user in local environment X wishes to run the report, the user can download both the appropriate RLU (which generically asks the appropriate question about information G) together with DC₁ (which provides the instruction to access the information G from data source Y). An author who creates an RLU may wish to create a suite of associated DCs to accommodate different local environments in which the report may potentially be generated. Alternatively, if no appropriate DC exists to run an RLU, a local environment can create its own custom DC.

The community report system 102 is community-based in the sense that multiple contributing sources (108, . . . 110) can supply RLUs (and associated DCs) to the community report system 102. Further, different local environments (104, . . . 106) can utilize the RLUs posted by the contributing sources (108, . . . 110). The contributing sources (104, . . . 106) can pertain to different entities. A contributing source may correspond to a company or other organization which creates an RLU (and/or DCs) for its own use. This company or other organization can then post the RLU (and/or DCs) for potential use by other parties.

In another case, any type of entity can supply an RLU in response to any kind of event or alarm that may affect the local environments (108, . . . 110). For example, a manufacturer may act as a contributing source. In response to a recall event, the manufacturer may post an RLU that allows local environments to identify the devices that need to be replaced. A software developer may also act as a contributing source. In response to the production of a new version of a program, the developer may post an RLU that allows local environments to identify the devices that need to be upgraded with the new version. In response to a virus alert, the developer can generate an RLU that allows local environments to identify devices that need to receive software patches, and so forth. The community report system 102 can emphasize reports that are associated with urgent alerts, e.g., by placing alarm messages next to these reports or by highlighting these reports through some other mechanism. This gives the administrators in the local environments an opportunity to address these alerts in expedited fashion.

While the above examples fall within the realm of information technology (IT), the contributing sources (108, . . . 110) may correspond to yet other types of entities that contribute RLUs in other contexts. To cite merely one example, a federal agency can act as a contributing source. In one scenario, the agency can issue an alert (and associated RLU) that communicates that a certain drug has been recently considered to be unsafe. Local pharmacies can access this RLU to generate reports for the purpose of purging this drug from their local inventories. In any event, the contributing sources (108, 110) can supply the RLUs (and/or DCs) by uploading this information to the community report system 102 via the network 112.

The community report system 102 may store the RLUs and DCs in various groups, such as report group A 114, report group B 116, and report group n 118. For example, report group A 114 can store a collection of RLUs: 120 and a collection of associated DCs 122, Different report groups can differ from other report groups in one or more respects. For example, different report groups can pertain to different respective report topics. For instance, a first group can relate to licensing issues, a second group can relate to product recall issues, and so on. Alternatively, or in addition, different report groups can correspond to different report sources. For instance, a first group can identify RLUs and DCs generated by vendor XYZ, a second group can correspond to RLUs and DCs generated by vendor LMN, and so on. In another case, a user (or other entity) can compile a collection of reports based on any criterion or plural criteria, and this collection can comprise one of the identified groups. Such a collection of reports comprises a type of “favorites list.”

Different report groups can be designated as private or public (or can be earmarked with some other access-related designation). In one case, private report groups can include information that can be accessed by only one entity (e.g., the authoring entity) or by a limited group of subscribing entities. The subscribing entities may optionally be asked to pay a fee in order to access the information in this type of report group. Public report groups can include information that can be generally accessed by any member of the community.

In one case, the community report system 102 can allow users to modify (LUs and DCs using a wiki-based model. In a wiki-based model, users may make changes to previously posted RLUs and DCs. The community report system 102 can maintain a log of changes that have been made, identifying the nature of the changes as well as the authors of the changes. Users may reverse any changes that are deemed inappropriate.

The community report system 102 can also include a statistical analysis module 124. The statistical analysis module 124 can compile information regarding the use of different RLUs and DCs by local environments (104, . . . 106). For example, the statistical analysis module 124 can identify the most frequently used RLUs. Alternatively, or in addition, the statistical analysis module 124 can receive statistical information that has been independently compiled by any contributing source (108, . . . 110) or other entity. Users can access the statistical analysis module 124 for various purposes, such as to identify popular RLUs. A popular RLU may reflect an RLU that performs well (which may explain its popularity). In a pay-for-use scenario, the statistical analysis module 124 can maintain accounting information that can be used to compensate contributing sources for the use of the RLUs that they have submitted.

In terms of physical implementation, the community report system 102 can correspond to any kind of data processing equipment. In one case, the community report system 102 can be implemented by one or more server computers and associated data storage devices, routers, and so forth. The community report system 102 can be administered using any kind of business paradigm, such as a web-type service. Likewise, each of the contributing sources (108, . . . 110) can correspond to any type of data processing equipment, such as one or more computers, data storage devices, and so forth.

Now turning to the local aspects of the system 100, a local environment may correspond to any setting in which a report is generated. For example, a local environment may correspond to any kind of organization, such as a company, a non-profit organization, an educational institution, a governmental entity, and so on. Or a local environment can generally correspond to a setting in which a single individual generates a report for his or her own use (e.g., the local environment in this case may correspond to the user's home).

Consider environment A 104, which will serve as a representative of all other environments. The local environment 104 uses a reporting module 126 to generate reports based on RLUs and DCs received from the community report system 102. The reporting module 126 is characterized as an “agnostic” reporting engine in the sense that it is configured to generate a wide variety of reports (as opposed to being “hardwired” to generate specialized reports that suit a particular purpose). Each local environment may include the same type of reporting module. To function as described, the reporting module 126 includes several submodules, each of which is explained in turn below.

First, the reporting module 126 includes a report selection module 128. The purpose of the report selection module 128 is to access the community report system 102, explore the reports that the system 102 offers, and download one or more RLUs (and/or DCs) associated with selected reports. Taking each operation in turn, the report selection module 128 can access the community report system 102 via the network 112 by inputting a network address of a website associated with the community report system 102. Upon accessing the community report system 102, the community report system 102 can present the report selection module 128 with one or more user interface presentation that identify the available reports. The community report system 102 can use different types of displays to convey the available reports. For example, the community report system 102 can present a menu of available report titles (and other salient information), optionally organizing the reports into different collections corresponding to different report groups (114, 116, . . . 118). The community report system 102 can also present, upon request, sample reports corresponding to the available report types. The user may click on a desired report to initiate the downloading of the corresponding RLU to the reporting module 126. There may be a set of available DCs corresponding to a selected RLU. In one case, the community report system 102 can also give the user the option of manually selecting one of these DCs, where the selected DC is appropriate for the reporting module's local environment 104. In another case, the community report system 102 can automatically select the correct DC to send to the reporting module 126 (e.g., based on information supplied in advance to the community report system 102). Upon downloading the RLU (and/or DCs), the report selection module 128 can store this information in one or more local stores (not shown). The bold-line arrow 130 graphically represents the downloading of an RLU/DC pair from the community report system 120 to the reporting module 126.

In another case, the community report system 102 can proactively download RLUs (and/or DCs) to the reporting module 126 (e.g., without being requested to do so by the reporting module 126). For example, a reporting module 126 can create a filter that describes the type of reports it wishes to receive. The community report system 102 can monitor the receipt of new RLUs (and/or DCs) and send any RLUs (and/or DCs) that meet the criterion or criteria identified in the filter. Reports can optionally be automatically generated based on the received RLUs and DCs without the intervention of the user.

Alternatively, a user in the local environment 104 may find that there is currently no RLU and/or DC that meets his or her current reporting needs. In this case, the user may rely on an authoring module 132 to create the RLU and/or DC. In one case, the authoring module 132 can correspond to a text processor or other tool for inputting textual information to create the RLU and/or DC. The authoring module 132 can optionally include a validation mechanism for ensuring that the RLU and/or DC is well-formed (meaning that the RLU and/or DC complies with pre-established rules). After creation, the user may optionally post the generated RLU and/or DC to the community report system 102 for use by others. In this sense, the authoring module 132 can be considered as one of the contributing sources (108, . . . 110) (e.g., insofar as it contributes to the body of information maintained by the community report system 102). The bold-line arrow 134 graphically represents the uploading of an RLU and/or DC from the reporting module 126 to the community report system 102.

A mapping module 136 is used generate a report based on an RLU and DC downloaded by the community report system 102 (or locally created by the authoring module 132). Assume for purposes of this explanation that the report selection module 128 downloads a particular RLU 138 and DC 140. Recall that the RLU 138 asks a general question concerning a topic, while the DC 140 identifies where the information needed to answer the question can be obtained within a particular local setting—in this case, within local environment A 104. In the representative system 100 of FIG. 1, the local environment A includes a variety of data stores (142, . . . 144). Thus, the DC 140 can link the RLU 138 to one or more of these data stores (142, . . . 144). Although FIG. 1 shows that the data stores (142, . . . 144) are located within the local environment 104, the DC 140 can also link to one or more sources outside of the local environment 104. For example, the DC 140 can link to one or more remote network-accessible data sources. Based on the combination of the RLU 138 and the DC 140, the mapping module 136 can assembly all of the information it needs to generate the desired report.

A report outputting module 146 can receive the data collected by the mapping module 136 and output a report to the user that provides this data. The report outputting module 146 can generate the report using various selectable formats.

A user can utilize the generated report for various purposes. In one case, the user can use the report to address problems or other needs within an organization. To this end, the report module 126 can incorporate or otherwise link to a remediation module 148. The remediation module 148 allows the user to take action based on a generated report. In one case, the user can review the report and manually take action within an organization based on action items identified in the report. In this context, the remediation module 148 may perform a bookkeeping operation, e.g., by recording the corrective actions that the user takes within the organization. In another case, the remediation module 148 can perform a more active role by automatically taking corrective action within the organization. For example, assume that the purpose of the report is to identify computers that include software product XYZ version 1.2, so that these computers can be upgraded to XYZ version 1.3. The remediation module 148 can automatically access the identified computers and install XYZ version 1.3 on these computers. The remediation module 148 can perform yet other types of automated or semi-automated actions within the local environment 104. In one particular case, the remediation module 148 may represent a third party module that the reporting module 126 links to in order to perform the desired corrective actions.

The remediation module 148 can also performs various actions to determine the effects of the above-described corrective actions. For example, the user may manually rerun a report to identify any computers that still need to be upgraded to software product XYZ version 1.3. Alternatively, the remediation module 148 can automatically rerun the report, followed by a second round of corrective action to address any lingering tasks that need to be performed.

In terms of physical implementation, the reporting module 126 can be implemented by one or more computer processing devices (e.g., a personal computer, laptop computer, etc.). Alternatively, the reporting module 126 can be implemented by a personal digital assistant device (PDA), a graphical tablet-type input device, a mobile telephone device, any kind of wearable/portable computing device, a game console, a set-top box device, or any other type of device.

A.2. Exemplary Mapping Functionality

FIG. 2 illustrates in greater detail how an exemplary RLU 202 and corresponding DC 204 can be used to generate a report. In this case, assume that the report identifies data processing equipment within an organization that needs to be upgraded. In this case, the RLU can include a collection of data fields that identify components of the data processing equipment that need to be updated, such as CPU, RAM, hard drive (HD), video card or monitor, etc. Further, in this particular case, the RLU 202 can identify the cost of each upgrade. For example, the RLU 202 identifies that it will cost $2000 dollars to upgrade the CPU.

The DC 204 identifies where information regarding the data fields in the RLU 202 can be found within the organization. In this case, the DC 204 identifies that information regarding the CPU, RAM, and HD can be found in a data store 206, while information regarding the video card can be found in data store 208.

The RLU 202 and 204 represent high level metadata that can be expressed in any suitable format. For example, this information can be expressed in the extensible markup language (XML), and the proper formatting of such files can be governed by appropriate schema.

A.3. Exemplary Processing Functionality

FIG. 3 sets forth exemplary processing functionality 302 that can be used to implement any aspect of system 100 shown in FIG. 1. In one non-limiting case, for instance, the processing functionality 302 may represent any computer machine used by the system 100, e.g., to implement any aspect of the community report system 102, any aspect of the contributing sources (108, . . . 110), any aspect of the reporting modules, and so on.

The processing functionality 302 can include various volatile and non-volatile memory, such as RAM 304 and ROM 306, as well as one or more central processing units (CPUs) 308. The processing functionality 302 can perform various operations identified above when the CPU 308 executes instructions that are maintained by memory (e.g., 304, 306, or elsewhere). The processing functionality 302 also optionally includes various media devices 310, such as a hard disk module, an optical disk module, and so forth.

The processing functionality 302 also includes an input/output module 312 for receiving various inputs from the user (via input devices 314), and for providing various outputs to the user (via output devices 316). One particular output device may include a display apparatus and an associated graphical user interface (GUI) 318. The processing functionality 302 can also include one or more network interfaces 320 for exchanging data with other devices via one or more communication conduits 322. One or more communication buses 324 communicatively couple the above-described components together.

The communication conduits 322 can be implemented in different ways to suit different technical and commercial environments. For instance, the communication conduits 322 can include any kind of network (or combination of networks), such as a wide area network (e.g., the Internet), an intranet, Digital Subscriber Line (DSL) network infrastructure, point-to-point coupling infrastructure, and so on. In the case where one or more digital networks are used to exchange information, the communication conduits 322 can include various hardwired and/or wireless links, routers, gateways, name servers, and so on. The communication conduits 322 can be governed by any protocol or combination of protocols. (In the context of FIG. 1, the communication conduits 322 may represent the networks 112.)

B. Exemplary Procedures

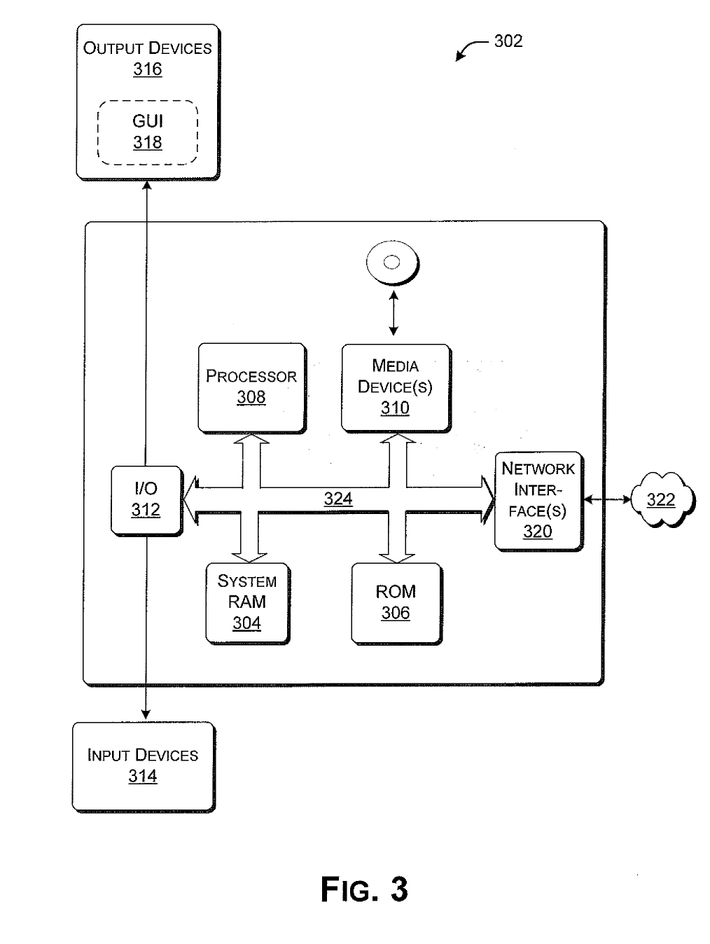

FIGS. 4-9 show various procedures which explain the operation of the system 100 in flow chart form. To facilitate discussion, certain operations are described as constituting distinct blocks performed in a certain order. Such implementations are exemplary and non-limiting. Certain blocks described herein can be grouped together and performed in a single operation, and certain blocks can be performed in an order that differs from the order employed in the examples set forth in this disclosure. The blocks shown in the flowcharts can be implemented by software, firmware, hardware, manual processing, any combination of these implementations, and so on.

As the functions described in the flowchart have already been set forth in Section A, Section B serves principally as a review of those functions.

B.1. Operation from the Perspective of a User

FIGS. 4-6 show procedures (400, 500, 600) that explain the operation of the system 100 from the perspective of an end-user (that is, from the perspective of someone using the system to generate a report).

Starting with FIG. 4, this procedure 400 corresponds to a method for selecting and downloading an RLU and/or DC from the community report system 102.

In block 402, the user accesses the community report system 102 to peruse the available reports. In doing so, the user can be apprised of various events that may impact the user's local environment. Or the user may access the community report system 102 with specific reporting needs already in mind. In any event, the user may select a desired report through this process and download a corresponding RLU and/or DC.

In block 404, the user can use the mapping module 136 to collect the necessary information to create the desired report. This involves mapping the RLU to various data stores within the user's local environment using the downloaded DC.

In block 406, the user can use the report outputting module 146 to generate the report.

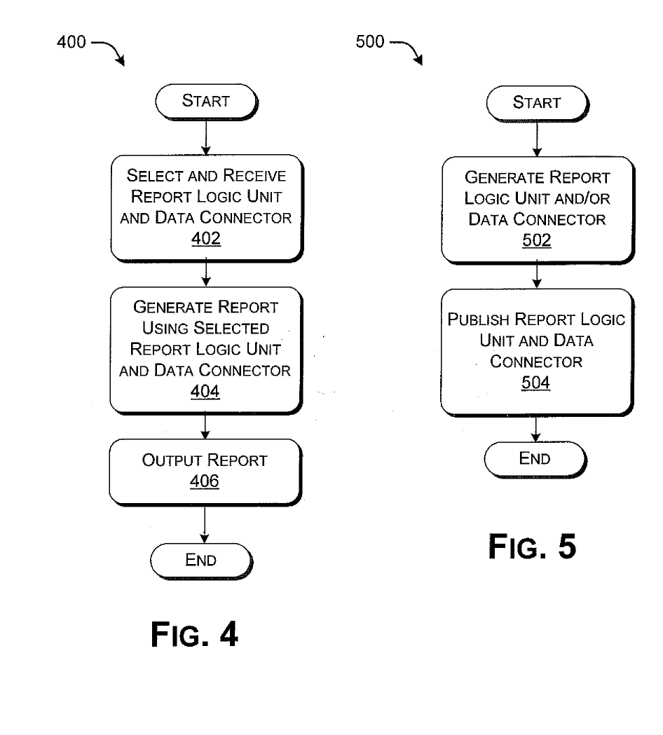

Procedure 500 in FIG. 5 corresponds to a method for authoring an RLU and/or DC. A user may opt to undergo this procedure if the user cannot find an existing RLU and/or DC in the community report system 102 that meets his or her needs.

In block 502, the user creates a new RLU and/or DC. The user may rely on the authoring module 132 to perform this task, which may involve inputting textual information that defines the RLU and/or the DC.

In block 504, the user may optionally post a newly created RLU and/or DC to the community report system 102. This allows the user to share the RLU and/or DC with others in the community.

FIG. 6 shows a procedure 600 that allows a user to take action based,on one or more issues identified in a generated report.

In block 602, the user can identify a problem within an organization (or other setting). As described above in connection with FIG. 4, the user can perform this operation by accessing the community report system 102 to determine whether a pertinent alert (and corresponding RLU) has been posted by a member of the reporting community. If so, the user then proceeds to download an appropriate RLU and DC for use in generating a desired report.

In operation 604, the user can take various actions within the organization to address the issues identified in the generated report. The user can rely on the remediation module 148 to perform this task. This operation can be performed manually, in automatic manner, or in semi-automated manner.

In operation 606, the user can verify that the issues identified in block 604 have been properly addressed. This may involve rerunning a desired report to determine the impact of the remediation operation in block 604.

B.2. Operation from the Perspective of the Community Report System

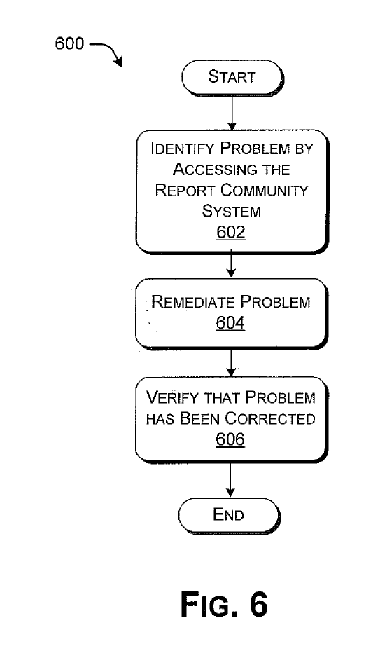

FIGS. 7-9 show procedures (700, 800, 900) that explain the operation of the system 100 from the perspective of the community report system 102.

Starting with FIG. 7, this procedure 700 corresponds to a method for downloading an RLU and/or DC from the community report system 102 to the reporting module 126. This procedure 700 complements procedure 400 of FIG. 4.

In block 702, the community report system 102 is contacted by the reporting module 126 when the user selects an available report, the community report system 102 receives a request from the reporting module 126 for an RLU and corresponding DC.

In operation 704, the community report system 102 downloads the selected RLU and DC to the reporting module 126.

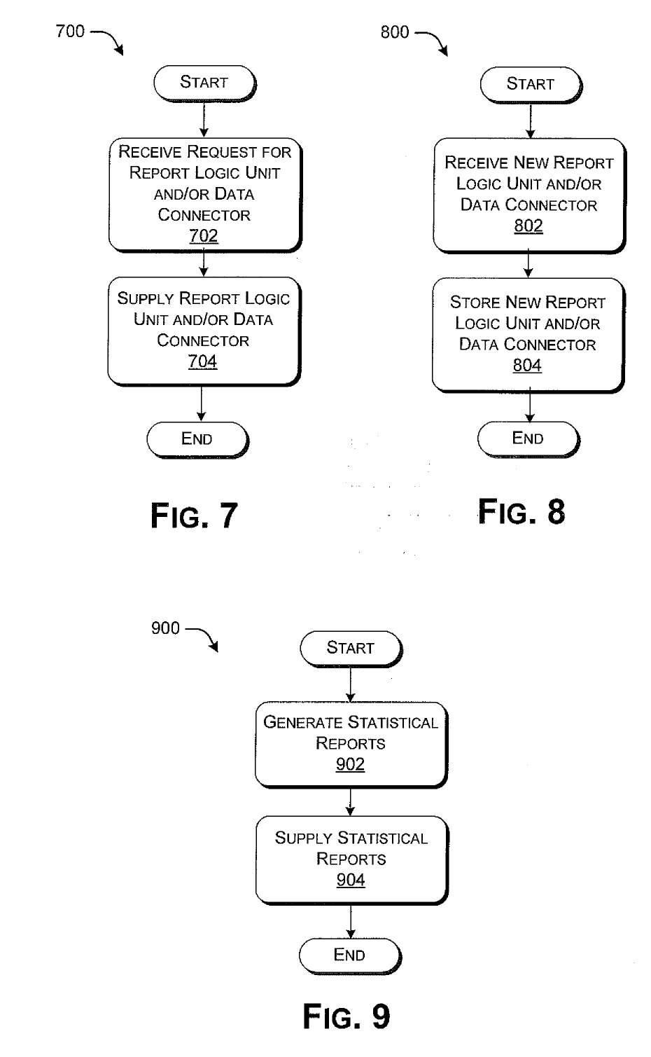

Procedure 800 of FIG. 8 corresponds to a method for receiving information from any contributing source (108, . . . 110) within the local environment 104 (recall that authoring module 132 is also considered a contributing source). This procedure 800 complements procedure 500 of FIG. 5.

In block 802, the community report system 102 receives one or more RLUs and/or one or more DCs from a contributing source (108, . . . 110).

In block 802, the community report system 102 stores the received RLUs and/or DCs. The community report system 102 may store this information in one or more appropriate report groups (114, 116, . . . 118).

Procedure 900 of FIG. 9 corresponds to a method for generating statistical reports by the statistical analysis module 124.

In operation 902, the statistical analysis module 124 compiles statistical information. The statistical analysis module 124 can prepare this information based on data that it collects regarding the utilization of RLUs and/or DCs. The statistical analysis module 124 can directly perform data collection and computation operations, or can receive already-compiled statistical information from a contributing source (108, . . . 110) or other entity.

In operation 904, the statistical analysis module 124 supplies the generated statistical information to one or more requesting entities.

In closing, a number of features were described herein by first identifying exemplary problems that these features can address. This manner of explication does not constitute an admission that others have appreciated and/or articulated the problems in the manner specified herein. Appreciation and articulation of the problems present in the relevant art(s) is to be understood as part of the present invention.

More generally, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A system for generating reports, comprising:
a community report system, comprising:
at least one report store configured to store a plurality of report logic units, the report logic units corresponding to respective reports;
a reporting module, comprising:
a report selection module configured to retrieve a selected report logic unit from the community report system, the selected report logic unit corresponding to a desired report;
a mapping module configured to retrieve data identified by the selected report logic unit from at least one data store; and
a report outputting module for outputting the desired report, wherein the desired report is created based on the selected report logic unit and the retrieved data; and
a communication conduit for coupling the community report system to the reporting module.

2. The system of claim 1, further comprising at least one authoring module that is configured to create a new report logic unit and to post the new report logic unit to the community report system.

3. The system of claim 1, wherein the mapping module is configured to use a data connector to map at least one data field identified in the selected report logic unit to said at least one data store.

4. A computerized method of facilitating the generating of reports, comprising:
receiving and storing a plurality of report logic units from at least one authoring module within a community of authoring modules;
receiving a request from a local environment for a selected one of the plurality of report logic units; and
forwarding the selected report logic unit to the local environment for use by the local environment in generating a desired report.

5. The computerized method of claim 4, wherein the selected report logic unit includes at least one data field which identifies data to be retrieved in generating the desired report.

6. The computerized method of claim 4, further comprising receiving and storing a plurality of data connectors, wherein each data connector identifies how at least one data field in a corresponding report logic unit is to be mapped to at least one data source.

7. The computerized method of claim 4, wherein the plurality of report logic units are maintained in a collection of report groups, each report group being distinguished from other report groups by one or more characteristics.

8. The computerized method of claim 7, wherein a first report group maintains report logic units that are privately accessible to at least one appropriately authorized local environment, and wherein a second report group maintains report logic units that are publicly accessible to any local environment.

9. The computerized method of claim 4, further comprising maintaining statistical information regarding the utilization of the plurality of report logic units by a plurality of local environments.

10. The computerized method of claim 4, wherein at least one of the plurality of report logic units addresses an issue pertaining to utilization of computer equipment by the local environment.

11. One or more machine-readable media containing machine-readable instructions for implementing the computerized method of claim 4.

12. One or more computing devices, comprising:
one or more processors; and
memory to store computer-executable instructions that, when executed by the one or more processors, perform the computerized method of claim 4.

13. A computerized method for generating reports, comprising:
accessing a community report system to review available reports;
selecting a desired report from the available reports;
receiving a selected report logic unit from the community report system corresponding to the selected report;
retrieving data identified by at least one data field in the selected report logic unit from at least one data store; and
outputting the desired report, wherein the desired report is created based on the selected report logic unit and the retrieved data.

14. The computerized method of claim 13, further comprising:
creating a new report logic unit; and
posting the new report logic unit to the community report system.

15. The computerized method of claim 13, wherein said retrieving of the data uses a data connector to map said at least one data field identified in the selected report logic unit to said at least one data store.

16. The computerized method of claim 15, farther comprising also retrieving the data connector from the community report system.

17. The computerized method of claim 13, further comprising:
using the desired report to address a task within the local environment; and
verifying that the task has been addressed by generating another report.

18. The computerized method of claim 13, wherein the selected report logic unit addresses an issue pertaining to utilization of computer equipment by the local environment.

19. One or more machine-readable media containing machine-readable instructions for implementing the computerized method of claim 13.

20. One or more computing devices, comprising:
one or more processors; and
memory to store computer-executable instructions that, when executed by the one or more processors, perform the computerized method of claim 13.
